(19) United States
(12) Patent Application Publication
(10) Pub. No.: US 2014/0246555 A1
(43) Pub. Date: Sep. 4, 2014

(54) Rest Foot for Stabilizers

(71) Applicant: Andrea Tres, Induno Olona (IT)

(72) Inventor: Andrea Tres, Induno Olona (IT)

(73) Assignee: SIRTRES S.r.l., MUGGIO (IT)

(21) Appl. No.: 14/235,487

(22) PCT Filed: Jul. 24, 2012
(86) PCT No.: PCT/IB2012/053757

§ 371 Date: Apr. 28, 2014

(30) Foreign Application Priority Data
Jul. 28, 2011 (IT) GE2011A000082

(51) Int. Cl. B60S 9/02; F16M 13/00

(52) U.S. Cl. CPC B60S 9/02; F16M 13/00
USPC 248/357; 280/763.1

(57) ABSTRACT

Support foot for stabilizers, comprising a frustoconical support member with a base of large diameter, made of plastic or polymer material, characterized in that it comprises means for the the effective and secure, but quickly and conveniently disengageable, connection of said foot to the end of the rod of a hydraulic or mechanical jack.

The present invention relates to stabilizers for self-propelled cranes, truck-mounted cranes, ladders, hoists, scaffolding, steel structures or similar apparatus operating in a cantilevered way, with load capacities of up to several tonnes. In order to increase the stability of said equipment, use is made not only of counterweights but also of mechanical supports (lifting jacks, racks or hydraulic jacks) which also reduce the stresses on the suspension of the vehicles.

At the present time, the ground support feet which are used are either rigid plates (known as “pads”), which have the heads of the shanks of the mechanical supports, such as hydraulic jacks, bearing on them (although these have considerable drawbacks in that they are not always satisfactorily adaptable to the irregularities of the ground), or supporting members with feet made of plastic or polymer materials, which are more satisfactorily adaptable to any unevenness in the ground.

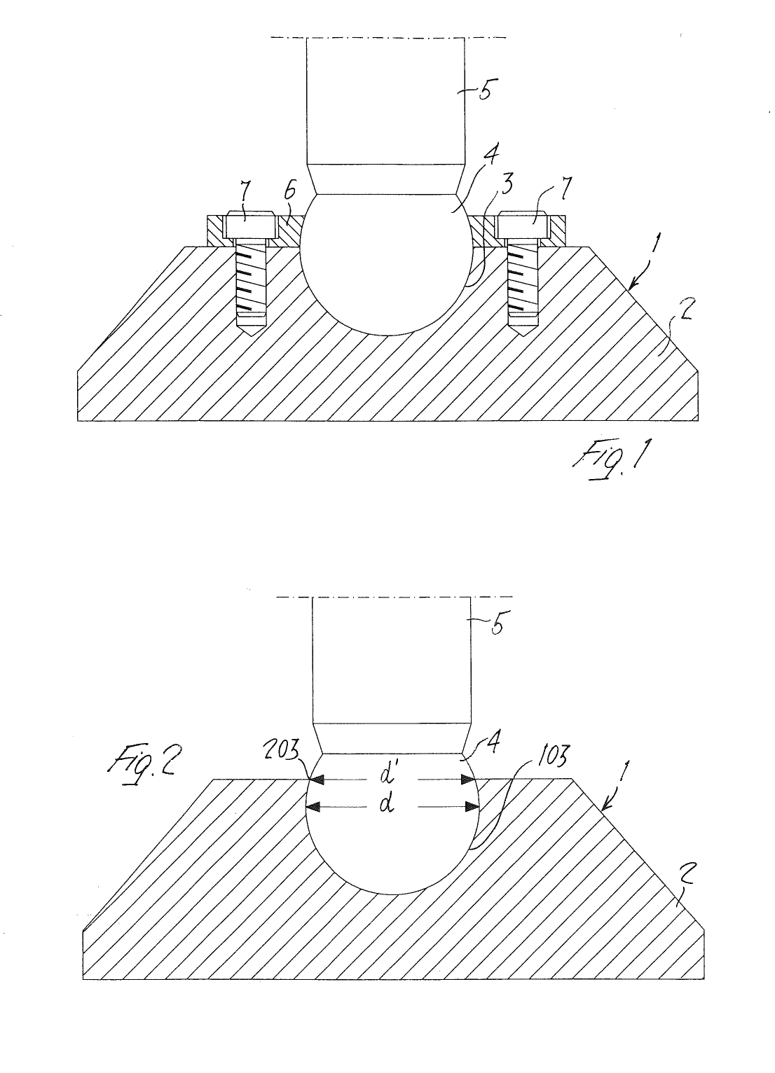

A known supporting member of the type having a foot made of plastic or polymer material, which has been found to be particularly effective, is shown in FIG. 1 of the attached drawings.

With reference to this figure, the number 1 indicates the foot of plastic or polymer material. A foot of this type is generally composed of a block of frustoconical or other shape, having a base 2 made of a plastic or polymer material such as PA6 (polyamide 6). A spherical cavity 3 is formed in the foot 1, and the spherical head 4, fixed to the rod 5 of a hydraulic jack (not shown), is engaged in this cavity. The head 4 is fastened to the block 1 by means of a flange of metal or plastic material 6 made in two halves, delimiting an opening machined spherically so as to mate with the shell of the ball 4, and the flange 6 is secured stably to the foot 1 by means of bolts 7. Clearly, this type of mounting is complicated, and the operations of fitting the foot 1 on the jack 5 and removing it therefrom are time-consuming.

The object of the present invention is therefore to provide a system for coupling a rod of a hydraulic jack or similar mechanical support device to a support foot which overcomes the drawbacks of the prior art devices.

This object is achieved by means of a device as claimed in claim 1.

Further objects and advantages will be made clear by the following description, which makes reference to the attached drawings, in which:

FIG. 1 is a view in diametric section, with some parts in view, of a support foot according to the prior art;

FIG. 2 is a view in diametric section, with some parts in view, similar to that of FIG. 1, showing a first embodiment of a support foot according to the present invention;

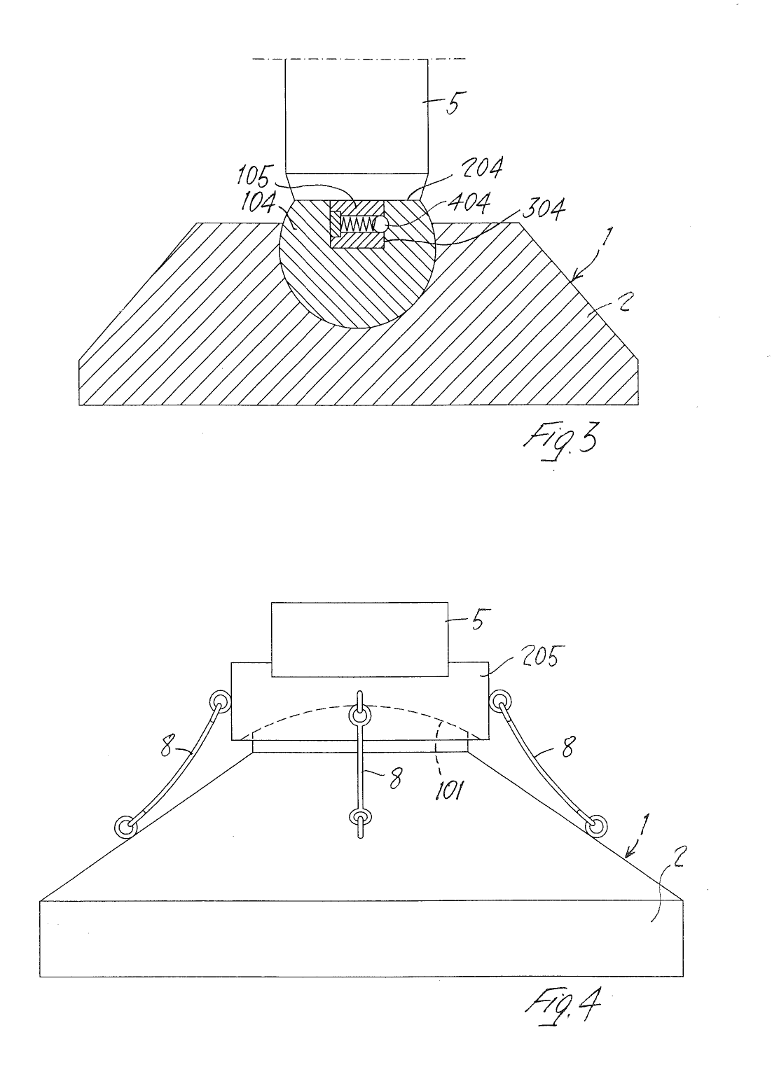

FIG. 3 is a view in diametric section, with some parts in view, similar to those of FIGS. 1 and 2, showing a second embodiment of a support foot according to the present invention, and

FIG. 4 is a view in side elevation of a third embodiment of a support foot according to the present invention.

In the following description, identical or corresponding parts will be identified with the same reference numerals.

Additionally, where reference is made in the following description to a hydraulic jack, it is to be understood that this device may be replaced with a jack, a rack or a similar device capable of providing suitable mechanical support.

With reference to FIG. 2, the number 1 indicates the support foot, made of plastic or polymer material such as an aliphatic polyamide, for example polyamide 6. This foot is made in one piece in the form of a block of frustoconical or other shape, resting on a base 2. A spherical cavity 103 is formed in the foot 1 and extends beyond the median line of the sphere, so as to have a mouth 203 with a diameter d′ which is smaller than the diameter d of the ball 4 fixed to the rod 5 of a hydraulic jack (not shown), the degree of interference between the mouth 203 and the spherical head 4 being about 0.1% to 3%. Thus the spherical head 4 can be snap-fitted through the mouth 203 into the spherical cavity 103, by exerting a pressure appropriate to the diameter of the ball and the interference between the mouth 203 and ball 4, and can also be extracted by exerting an appropriate tractive force on the head.

Thus the rods of the hydraulic jacks (or similar supporting means) of the equipment to be stabilized are engaged with the feet 1 and/or disengaged therefrom in a quick and convenient manner, without the use of tools which would be necessary, for example, for the mounting and dismounting of the feet 1 shown in FIG. 1.

In the embodiment of the present invention shown in FIG. 3, the ball 104 is incorporated in the foot 1 by co-moulding, so as to project from the upper part of the foot 1 with a flat area 204, from the centre of which there extends a slot 304 into which is fitted a fitting member 105 fixed to the end of the rod 5 of a hydraulic jack. The fitting member 105 interacts with the slot 304 using resilient retaining means, such as the ball and spring means 404, in order to fasten the rod 5 of the jack to the foot 1. Clearly, it would be possible to omit the resilient retaining means, and it would be possible for the joint configuration, instead of being male on the end of the rod 5 of the jack and female on the ball 104 as illustrated, to be male on the ball 104 and female on the end of the rod 5 of the jack, thereby ensuring the cleanness of the coupling.

In this case also, the foot 1 is fastened to the rod 5 and detached therefrom quickly and conveniently, using a degree of force or traction appropriate to the dimensions and weight of the support foot and the incorporated metal ball.

FIG. 4 shows another variant of the present invention.

In this embodiment, the foot 1 has on its top a spherical dome 101, made in one piece with the material of the foot 1 and having a large bearing surface, which supports the metal spherical bearing 205 carried by the rod 5 of the jack.

The bearing 205 is connected stably to the foot 1 by links 8, and the fastening or detachment takes place between the rod of the jack and the bearing 205. Clearly, it is possible to leave the bearing 205 stably connected to the rod of the jack.

The present invention yields multiple advantages. Among other benefits, the solutions which have been described prevent water, mud or gravel from becoming trapped between the spherical head and the spherical socket, which would lead to malfunction, premature wear and unpredictable fracture under load.

Evidently, the present invention is not limited to the embodiments illustrated and/or described, but comprises all variants and modifications lying within the wider scope of the inventive concept, substantially as claimed below, and for the objects stated above.

1. Support foot for stabilizers, comprising a substantially frustoconical support member with a base of large diameter, made of plastic or polymer material, characterized in that it comprises means for the the effective and secure, but quickly and conveniently disengageable, connection of said foot to the end of the rod of a hydraulic or mechanical jack.

2. Support foot according to claim 1, characterized in that said means for the effective and secure, but quickly and conveniently disengageable, connection of said foot to the end of the rod of a hydraulic or mechanical jack comprise a spherical socket formed in said foot, the mouth of which has a smaller diameter than the diameter of said spherical socket, into which spherical socket is snap-fitted a spherical metal head which has a diameter complementary to the diameter of said spherical socket and which is carried by the rod of said hydraulic or mechanical jack.

3. Support foot according to claim 1, characterized in that said means for the effective and secure, but quickly and conveniently disengageable, connection of said foot to the end of the rod of a hydraulic or mechanical jack comprise a spherical housing, formed in said foot, in which is incorporated by co-moulding a metal ball having fitting means for its disengageable connection to said hydraulic or mechanical jack.

4. Support foot according to claim 1, characterized in that said means for the effective and secure, but quickly and conveniently disengageable, connection of said foot to the end of the rod of a hydraulic or mechanical jack comprise a spherical dome, made in one piece with the plastic or polymer material of said foot, on which a spherical metal socket is made to bear.

5. Support foot according to claim 1, wherein said plastic or polymer material of the foot is a polyamide.

6. Foot according to claim 5, wherein said polyamide is polyamide 6.
